(19) United States
(12) Patent Application Publication
(10) Pub. No.: US 2007/0025579 A1
(43) Pub. Date: Feb. 1, 2007

(54) Interchangeable personal audio device cables and cable covers

(76) Inventor: Timothy Val Kolton, W. Hollywood, CA (US)

Correspondence Address: Wilson Daniel Swayze, Jr., 3804 Clearwater Ct, Plano, TX, 75025, US

(21) Appl. No.: 11/331,739

(22) Filed: Jan. 13, 2006

Related U.S. Application Data
(60) Provisional application No. 60/702,827, filed on Jul. 27, 2005.
(60) Provisional application No. 60/702,838, filed on Jul. 27, 2005.

(51) Int. Cl. H04R 25/00

(52) U.S. Cl. 381/384

(57) ABSTRACT

Interchangeable cables and cable covers for a personal audio device includes a speaker and cable. An earphone, headphone, or communication headset cable may be disconnected permitting interchange with another cable or cable cover that has a different design, protective features, or function. In a method of customizing the audio device, the steps include (a) disconnecting at least one cable of the audio device; and (b) removing a previous cable and/or cable cover, if one is currently attached, and replacing it by a different cable and/or cable cover that provides a different design, functionality, or protective qualities.

### PRIORITY

The present invention claims priority based on 35 USC section 119 and provisional application 60/702,827 filed on Jul. 27, 2005 and provisional application 60/702,838 filed on Jul. 27, 2005.

### FIELD OF INVENTION

The invention pertains generally to cables that are used for personal audio devices typically worn on the head which connect to a source device used for audio, video, video games, or telephone calls. More specifically, the invention relates to the cables generally used for earpieces such as earphones, headphones, and wired communication headsets.

Portable music, cellular telephones, portable video game machines, and consumer electronics (hereafter referred to as “source”) in general have shrunk in size, functional capabilities have increased, and many products offer different technology capabilities in a single device. Technology convergence has been a desirable feature in consumer products. Many cellular telephones also are used as personal digital assistants, stereo music players, video games, cameras, and internet browsing devices. Many portable music players are also used to display photographs, play movies, store files, and play games. Many Personal Digital Assistants (PDAs) include the features of cellular telephones, portable music players, and gaming machines in one device. While using a source device, users often make use of a device that is worn on the head for audio input and output. The device includes at least one speaker which is connected to the device either with cables or a wireless connection such as Bluetooth or IEEE802.11, commonly known as Wi-Fi. A microphone on this device may be present for audio input for cellular telephone calls, games, video, or recording audio.

Additionally, many states and cities have made it illegal to drive a motor vehicle and use a cellular telephone without the use of a wired or wireless headset device. Although wireless headsets and headphones are available, many users prefer wired devices for their low-cost, quality, performance, lack of battery, lack of charger, availability, fashion, and convenience.

Conventional wired devices worn on the head, usually comprising of at least one earphone, used for listening to music or communication are designed with a fixed cable and plug. Users generally use earphones or headphones for listening to audio and a separate headset for communication. However, some earphones and headphones have a microphone and can also be used for making cellular telephone calls, and audio input. Source devices that function as both audio players and communication headsets are now available and users want more options for customizing and using the devices worn on the head that connect to their portable electronic devices.

While source devices are converging, many users often own at least one or more earphones, headphones, and headsets for each source. Furthermore, with the increasing use of wireless headsets and headphones, it is possible for a consumer to own at least four head-worn devices that each provides different functionality (audio, headset, wireless headset, and wireless audio) for one source device.

The cost of the head-worn device is often more expensive than the source device. Many service providers offer source devices for free in order to charge subscription or usage fees. Some earphones and headsets are made of very high quality components that cannot be used for other purposes besides their original purpose. Once a user has acquired a headphone or earphone, it cannot be easily retooled to be used as a headset. Headsets also cannot be easily retooled to be used as earphones or headphones at a later time. A user cannot make use of his premium earphone speakers for when communicating on a different headset.

Many cellular phone and PDA manufacturers do not use industry standard plugs or cables. This practice also necessitates acquiring a separate headset or earphones every time a different source is used or replaced.

The device is also worn on a user's head and in the proximity of their body and clothes. Many users have a desired objective of to permit the device to be customized in accordance with a unique and alterable aesthetic effect. The present head-worn devices and their cables are primarily available in white, grey, or black colors and are not user interchangeable with other colors or materials.

Many consumer product manufacturers differentiate their product offerings by offering unique design, styles, colors, and materials. Furthermore, many product manufacturers give users the ability to customize or “mod” their product. Additionally, consumers will often “mod” their consumer products that were not designed to be customized in order to suit their individual tastes, style, and functionality. Many consumers make their purchasing decision based on the design, style, and ability to be customized or “modded”. It is evident that users are demanding the ability to differentiate their products from their peer's product with or without the manufacturers consent. This is further true when user's products are often the exact same manufacturer and product that is prevalent at the time. Some large companies have even named the current consumers “Generation Remix” instead of Generation X or Y.

Although consumers can generally customize their source products, the options for customizing the accessory head-worn devices, and specifically their cables, are not prevalent. The current methods for customizing or repurposing head-worn devices are limited. One current method is to change covers of different colors on the outside part of a headphone or earphone as described in U.S. Pat. No. 5,625,171. Another method for customizing the head-worn device is to lengthen or shorten the connector cable with either a winding mechanism or a detachable extension cable consisting of both a standard female and male plug. Another common method is to attach a remote-control or volume control to the device. Although this method adds functionality of the device, it does not alter the primary functional utility of the device such as turning earphones into a cellular telephone headset or vice-versa. The last known method of customizing a head-worn device is primarily used for audio enthusiasts for improving the audio quality by altering the wire and shielding materials of the cable. However, none of the known methods are designed specifically to alter the primary functionality or decoration of the personal audio device.

Several products exist today that function as both stereo audio earphones and communication headsets. However, these current devices use non-interchangeable cables. They plug into the audio or communication device source by either having one plug that carries both the audio and microphone signals, two standard plugs attached to the end of one cable, or an adapter that changes the size or shape of the plug. No product permits the user to change the entire cable and plug to alter the functionality of the audio device.

Accordingly, what is needed is modular and user interchangeable cables and components for head-worn devices specifically designed for changing the functionality and for aesthetic customization. The present invention provides such a system.

### SUMMARY

The present invention is a personal audio device that is composed of at least one speaker, a cable, and a plug that has interchangeable cables. The interchangeable cables and functional components permit the device to be used specifically for multiple functionalities or for aesthetic customization configurations. The interchangeable cables, speakers, and plugs can vary in features which enable the device to be modular in both functionality and aesthetics. Since the nature and objective of the patent is to provide the user with a plurality of configurations, all derivative configurations should be covered under the current invention.

A desired objective of the invention is to permit users to change the cables of their head worn devices to alter the functional utility of the audio device. By permitting the user to interchange the cables and the components that attach to the cables, the user can configure their device with an unlimited combination of earphone speakers, cables, plugs, decoration, and microphones. A user could change the plug cable of a normal earphone speaker with a different speaker that includes a microphone built-into the speaker housing portion for audio input. A user would also have the ability to change the cable in order to fit the plug socket of a particular device. Several interchangeable cable plugs are common; 3.5 mm is used for stereo audio, 2.5 mm for communication headsets, specific cellular phone brand headset plugs, and Y-cord that includes both a 3.5 mm stereo and 3.5 mm microphone plug typically used for personal computers. Another configuration would be for the connector to contain a microphone for audio input, thus permitting the normal audio device to also provide functionality for audio input such as telephone calls.

An additional objective of the invention is to permit the user of the device to change the cable in accordance with a desire to provide a unique and alterable aesthetic effect. The interchangeable cables are designed specifically to vary in colors, ornaments, materials, functional features, and plugs.

Another objective of the invention is that the removable cable would also permit an additional cable cover to be used in conjunction with the interchangeable cable for further customizing the aesthetics of the cables. The interchangeable cable cover would be designed specifically to vary in colors, ornaments, materials, and provide protection from damaging the cable that is being covered. The benefits also include the ability to change removable covers so that it will allow the user to change the cable covers independently of cables. This provides the ability to change the aesthetics and to add additional protection to the device independently of the cable functionality, wire quality, plug type, or aesthetics. Since either the cover or cable and it's attached components and plugs may be of varying levels of cost and features, this feature gives the user increased benefits of reusing their previously acquired parts for different feature configurations and aesthetic customization.

In the preferred embodiment, each cable and component (earphone, microphone, connector, and plug) is interchangeable. However, in the interest of costs and ease of use, certain cables and components may be permanently attached for different products. The cable that plugs into the source may not have an attached connector that attaches to the earphones that may also contain a microphone for use as a cellular telephone headset or other functionality such as a remote control. By configuring the device this way, it will be easier to attach and use a cable cover for decorative or protective purposes as previously described.

The connectors used to disconnect the cables and components could be standard mono, stereo, stereo-microphone plugs, or other connectors that provide additional aesthetic or functional qualities. For instance, a connector that incorporates screw threads may be used in order to provide additional protection from inadvertent pulling of the device cables apart.

### BRIEF DESCRIPTION OF THE DRAWINGS

The invention may be understood by reference to the following description taken in conjunction with the accompanying drawings, in which, like reference numerals identify like elements, and in which:

FIG. 1 shows a perspective view of the interchangeable audio device as an earpiece with all pieces interchangeable;

FIG. 2 shows another configuration of the interchangeable cable for using the audio device as stereo earphones or communication headset;

FIG. 3 shows another configuration of the interchangeable audio device as an earphone or communication headset where earphones are permanently connected with a connector;

FIG. 4 shows another configuration of the interchangeable audio device as an earphone or communication headset where earphones are detachably connected with a plug;

FIG. 5 shows a perspective view of the interchangeable audio device as used with a radio;

FIG. 6 shows another configuration of the audio device used with a communication device;

FIG. 7 shows another configuration of the audio device with a decorative cable cover;

FIG. 8 shows another configuration of the audio device in which the interchangeable hearing device is used with an interchangeable decorative cable cover;

FIG. 9 shows a perspective view of the interchangeable audio device with detachably connected elements;

FIG. 10 shows a different configuration of the interchangeable cable;

FIG. 11 shows a configuration of the interchangeable audio device as an earphone or communication headset where the earphones cables are permanently connected with a plug;

FIG. 12 shows a configuration of the interchangeable audio device as an earphone or communication headset where earphones are permanently connected with a connector;

FIG. 13 shows a configuration of the audio device in which the stereo speakers are configured as headphones including a behind-the-neck or headband piece;

FIG. 14 shows another configuration of the audio device in which the device is configured for use as a communication headset;

FIG. 15 shows a configuration of the audio device in which the interchangeable eardevice is used with an interchangeable decorative cable cover;

FIG. 16 shows a perspective view of the audio device in which the connector receives audio and communication signals wirelessly from a source;

FIG. 17 shows a perspective view of the audio device in which the microphone is attached to the earpiece cables.

### DETAILED DESCRIPTION OF THE INVENTION

### Configurations of the Invention

As stated previously, the nature and objective of the patent is to provide the user with a plurality of configurations. Some of the common configurations will be described for using the interchangeable personal audio device as earphones, headphones, or as a communication headset.

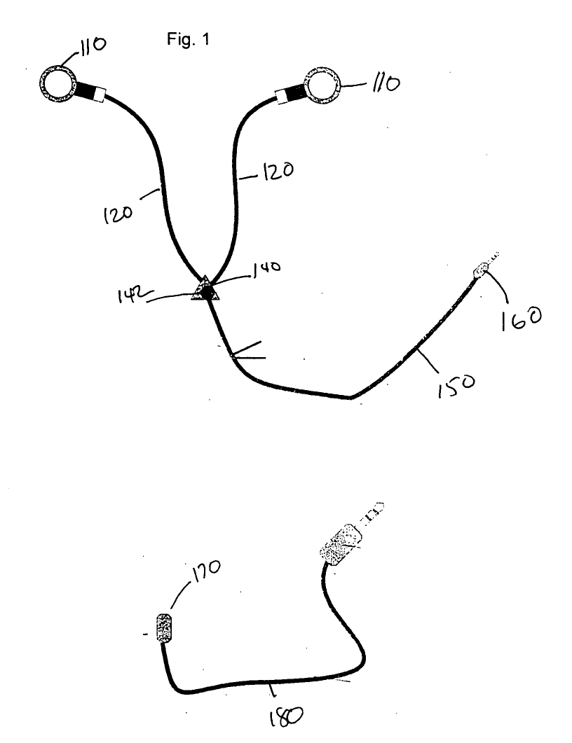

FIG. 1 illustrates a stereo earphone of the embodiment of the present invention including an earpiece (110) that is to be placed inside or around a user's ears, two earpiece cables (120) that attach to the earpiece (110) on one end of the earpiece cable (120) and to a connector (140) on the other end. The connector (140) may have multiple female jacks for the earpiece cables (120), a source cable (150) that houses a wire that carries the stereo signal, and a plug (160) which may be a 3.5 mm standard male stereo plug. The earpiece cables (120) and the source cable (150) may be detachably connected and may be interchangeable for different products.

With the present invention, the drawings may show a cable with a particular connector or the cable may be permanently connected to a component; however, the cable with the particular connector may instead be permanently connected in the cable with the permanent connection to a component could be connected with a connector. For example in FIG. 1, each earpiece cable (120) is connected to connector (140) with a jack, yet, the cables could utilize different connectors or be permanently attached to a component such as the earpiece (110).

An advantage of having multiple interchangeable cables (120) and (150) is that the user can change the decorative aesthetics of each cable independently for various color and material combinations. For instance, a user could have one cable red, one cable white, and another cable blue to show spirit for the United States of America.

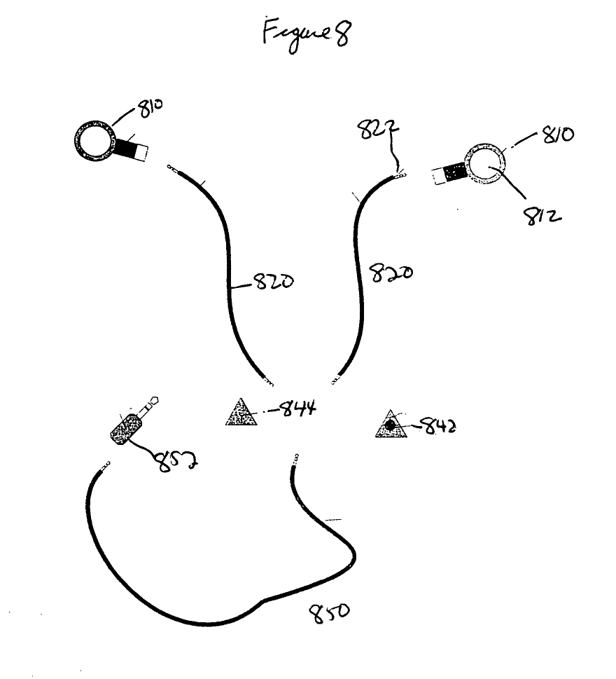

Generally, the source cable (150) may not be permanently fixed to the connector (140) or microphone (170). This will make it easier for the user to interchange cables or attach cable covers as described in detail in FIG. 8.

In a method of customizing this audio device to change a cable, the steps include (a) disconnecting at least one cable (120) or (150) of the audio device; and (b) replacing it with a different cable. The different cable could differ in aesthetics, such as decorative materials, cable colors, cable materials, protective qualities, and/or functionality.

In a method of customizing this audio device to change an earphone or earphones, the steps include (a) disconnecting at least one earpiece (110) from the earpiece cable (120); and (b) replacing the earpiece (110) with a different earpiece.

In a method of customizing this audio device to add the functionality of audio input, such as for use as a communication headset, the steps include (a) disconnecting a connector (140) that may not have a microphone from a earpiece cable (120) and/or source cable (150); and (b) attaching the earpiece cables (120) and/or source cable (150) to a connector (140) that includes a female jack for a microphone (170) such as shown in FIG. 1b. Variations of this method include but are not limited to earpiece (110) or earpiece cables (120) that include a microphone component instead of the microphone (142) on the connector (140).

Generally, the plug (160) may be a 3.5 mm plug when used for stereo audio. For use as a communication headset, the plug (160) is usually a 2.5 mm plug; however, it could be a plug designed for different manufacturer headset plugs. The single plug (160) could be replaced with two 3.5 mm plugs where one plug is used for audio output and one plug is used for audio input. This is the method that may be used when using a cable with a personal computer that generally has separate 3.5 mm plugs for audio input and output. This configuration is popular for internet-based communication such as Skype.

In another alternative of this configuration, the connector (140), or the source cable (150) may include a wireless functionality component (such as Bluetooth or 802.11b). This could eliminate the need to attach the earpiece cable (120) to the earpiece (110). In this method, a wireless microphone (170) could be attached to the wireless earpiece (110), the wireless connector (140), or the wireless source cable (150).

In another alternative of this configuration, the connector (140), earpiece (110), or one of the earpiece cables (120) includes a wireless functionality component (such as Bluetooth or 802.11b). This may eliminate the need to attach a source cable (150) to a source device such as a personal audio device. Additionally, the wireless functionality would permit the personal audio device to be connected to a second audio device attached with a source cable (150) and at least one wireless device at the same time.

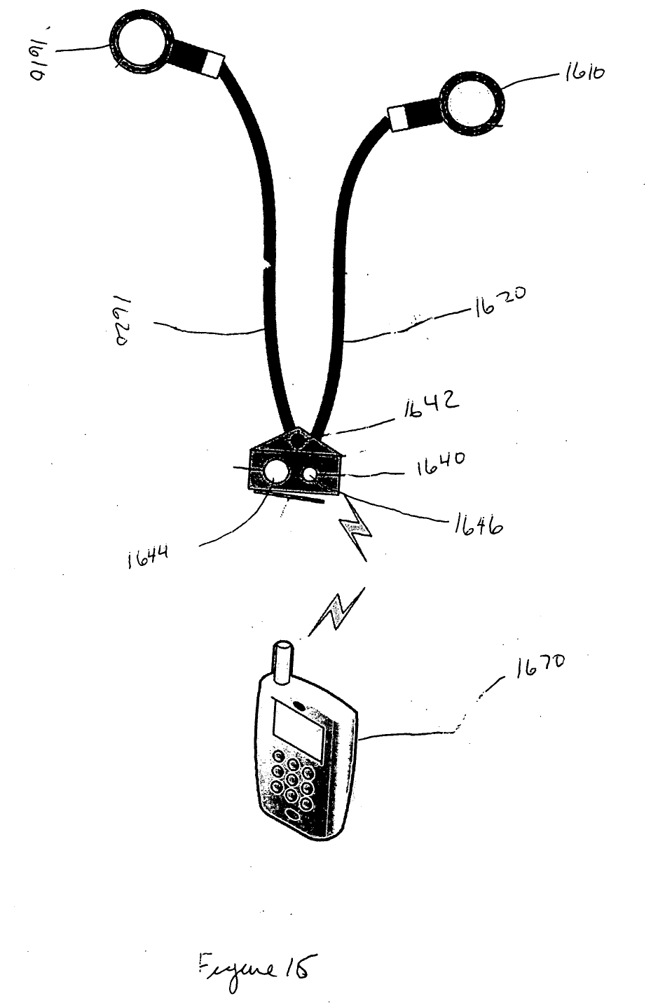

FIG. 16 illustrates one aspect of the present invention that includes the wireless functionality. The source 1670 broadcasts audio or communication signals wirelessly to the connector 1640 which converts the audio or communication signals that have been transmitted wirelessly to a signal that can be transmitted through the source cable 1650. The wireless communication may be compatible with Bluetooth or WiFi. The connector 1640 includes a microphone 1642, first socket 1644 and second socket 1646. A first socket 1644 may accept a 3.5 mm jack, and the second socket 1646 may accept a 2.5 mm jack.

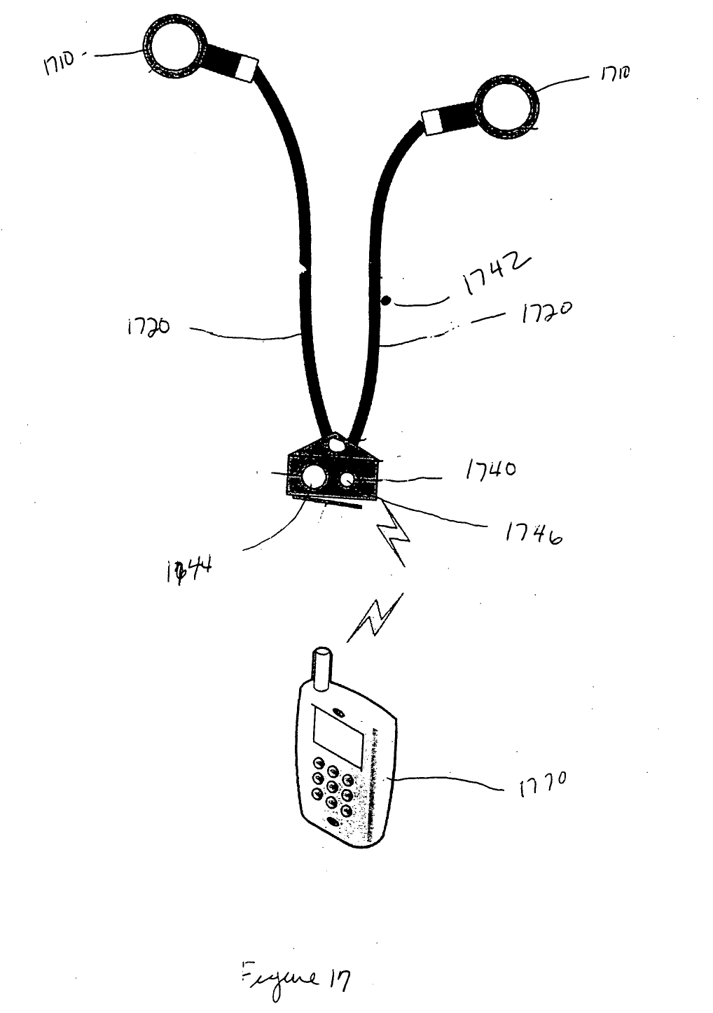

FIG. 17 illustrates a similar device as shown in FIG. 16. However, microphone 1742 is mounted on the source cable 1620.

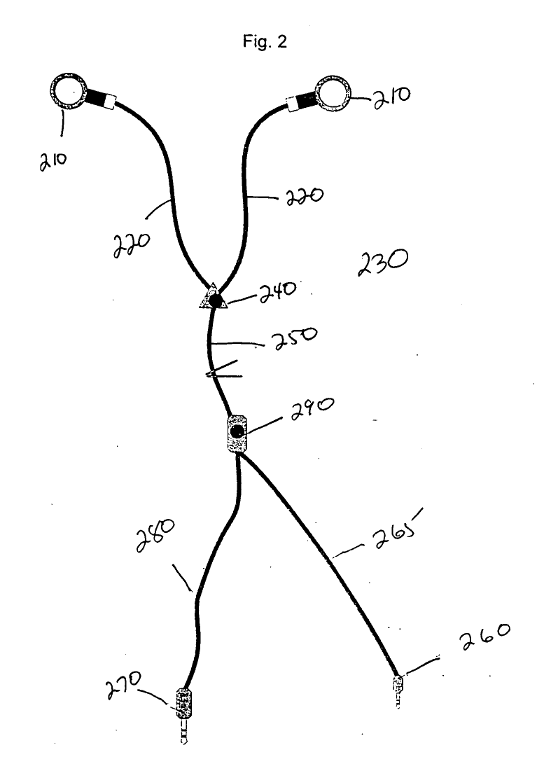

FIG. 2 illustrates an alternative configuration of the audio device with an interchangeable cable for using the audio device as an earphone or communication headset. In this embodiment, the earpiece (210) is permanently connected to the earpiece cable (120). The source cable (250), connector (240), and plug (260) which may be a 3.5 mm stereo plug are also connected to form an integral component (230). In this configuration, a user could interchange a first integral component (230) with another second integral component (230) to vary the aesthetics or functionality.

FIG. 2 illustrates that the second source cable (280) can not be directly attached to the connector (240) without removing the source cable (250). FIG. 2 additionally shows that the source cable (250) is detachable connected to a second connector (290) which is in turn detachable connected to the first source cable (265) and the second source cable (280). FIG. 2 allows the connection of an additional source cable namely the second source cable (280).

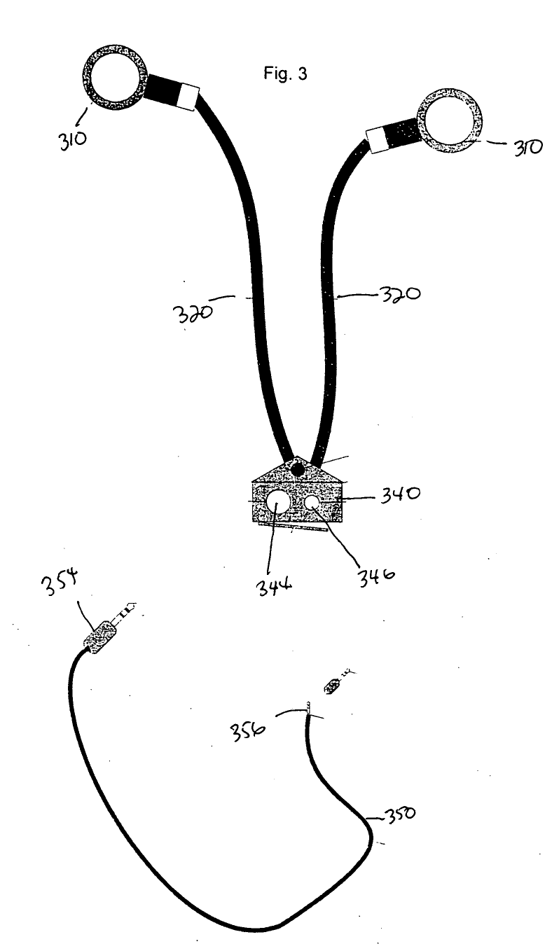

FIG. 3 illustrates an alternative configuration of the audio device in which the earpiece (310) is permanently connected to a connector (340). In this embodiment, the stereo earpiece cables (320) are permanently connected to each other by the connector (340). The connector (340) includes a first socket (344) to accept a first plug (354) and a second socket (346) to accept a second plug (356). For purposes of illustration, source cable (350) includes the first plug (354) on one end and the second plug (356) on the other end. In this configuration, a user could interchange the source cable (350) with another source cable (350) by connecting the source cable plug (354) into the connector (340) to vary the aesthetics or functionality.

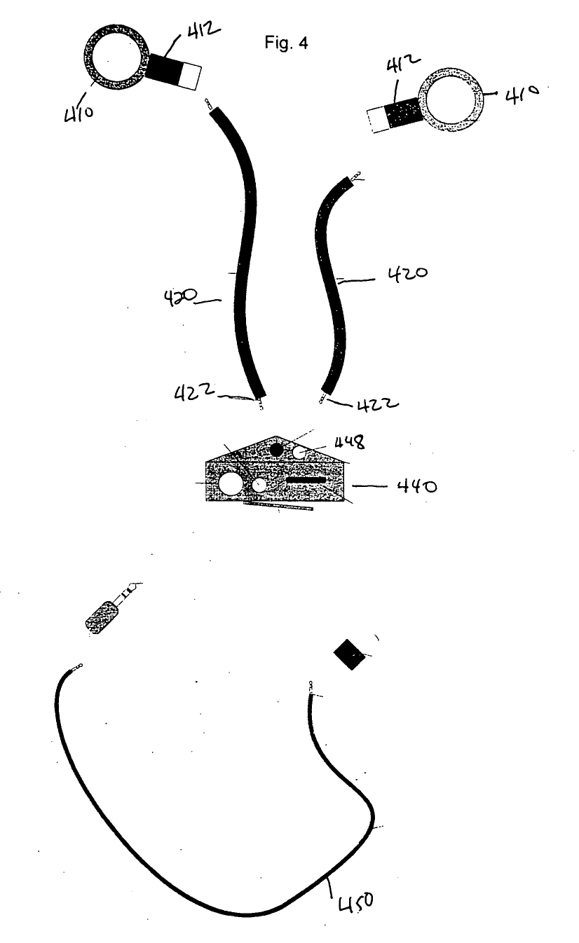

FIG. 4 illustrates an alternative configuration of the audio device in which the earpieces (410) are permanently connected to a plug (412) that is detachably connected to an earpiece cable (420) with a connector (440). In this embodiment, the earpiece cables (420) are permanently connected to an earpiece plug (422) which plugs into socket 448. In this configuration, a user could interchange the earpiece cable (420) with another earpiece cable (420) by connecting the connector (440) to the earpiece plug (422) to vary the aesthetics or functionality.

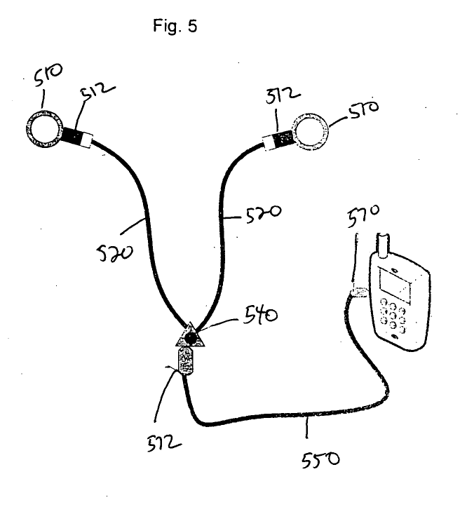

FIG. 5 illustrates an alternative configuration of the audio device in which the earphones include a microphone on the connector. In this embodiment, the earpiece cables (520) are permanently connected to each other and with a connector (540) that includes a microphone (570). The source cable (550) attaches to the connector (540) with a source cable plug (572). The source cable plug (572) on the source cable (550) may be designed for use with communication headsets. Generally, the plug (572) is a 2.5 mm plug; however it could be a plug designed for varying manufacturers headset plugs. Another alternative of this method would be for the connector (540) to be directly attached to the source cable (550).

In a method of customizing this audio device to use the device for stereo audio input, which enables features of a communication headset, the steps include (a) disconnecting the source cable (550) that is designed for headset communication by disconnecting the source cable plug (572); and (b) plugging another source cable plug (572) into the connector (540) of a source cable that is designed for stereo audio using a stereo audio plug that may be 3.5 mm.

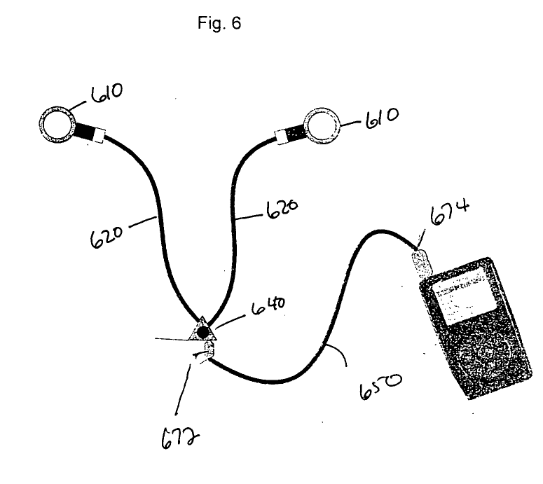

FIG. 6 illustrates another embodiment of the present invention which is similar to FIG. 5. In FIG. 6, the microphone (570) has been replaced with a second plug (674) which detachably connects the source cable (682) to the source for example a radio.

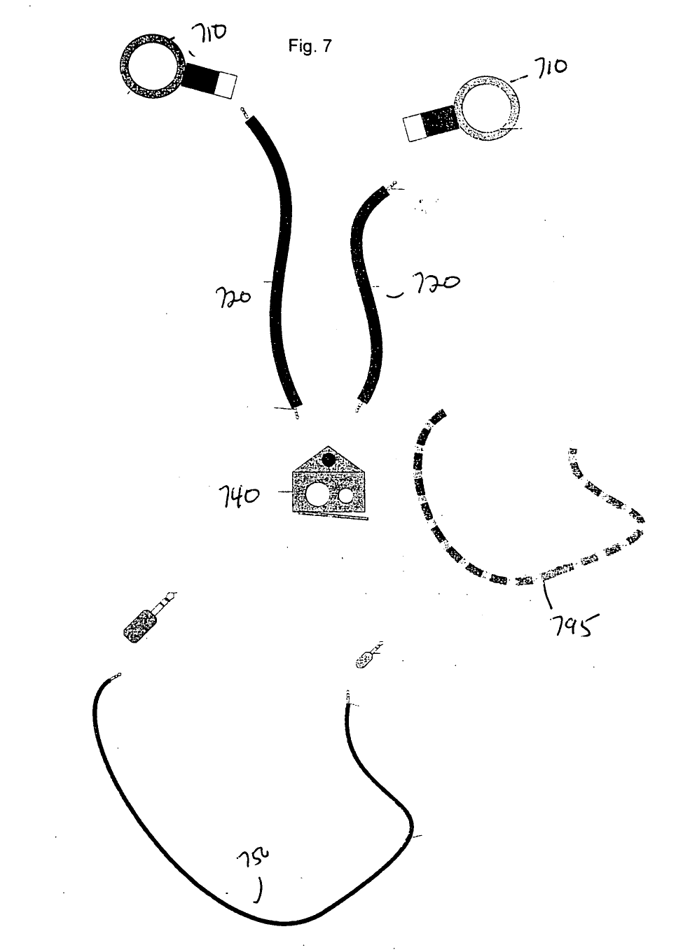

FIG. 7 illustrates another embodiment of the present invention in which a cable cover (795) may have a decorative cover in order to be aesthetically pleasing. The cable cover (795) is a sufficient length so that the cable cover (795) can be shortened to cover the earpiece cable (720) or the source cable (750).

FIG. 8 illustrates a stereo earpiece model of the embodiment of the invention that includes earpieces (810) that are placed inside or around a user's ears, two earpiece cables (820) that attach from each earpiece (810), a first connector (842), a second connector (844) that includes three female jacks for the cables (820, 850) and a source cable (850) that houses a wire that carries the stereo signal, and a 3.5 mm standard male stereo plug (852). The invention describes at least one of the three cables is to be interchangeable, but each of the cables would have the ability to be interchangeable for different products. In the drawings, each cable has a plug (822) so that the cable is detachably connected at an end; however, the cables could utilize different connectors or could be permanently attached to a component such as the earpiece (810). For example, the earpiece cable (820) and earpiece speaker (812) could be separate interchangeable pieces as shown in the drawing, or the earpiece speaker (812) could be permanently attached to the earpiece cable (820). Additionally, the connector (844) could be a separate interchangeable piece or permanently attached to the earpiece cables (820) leading to the earpiece (810) or could be permanently attached to the source cable (850) leading to the plug (852) that detachably connects to the source device.

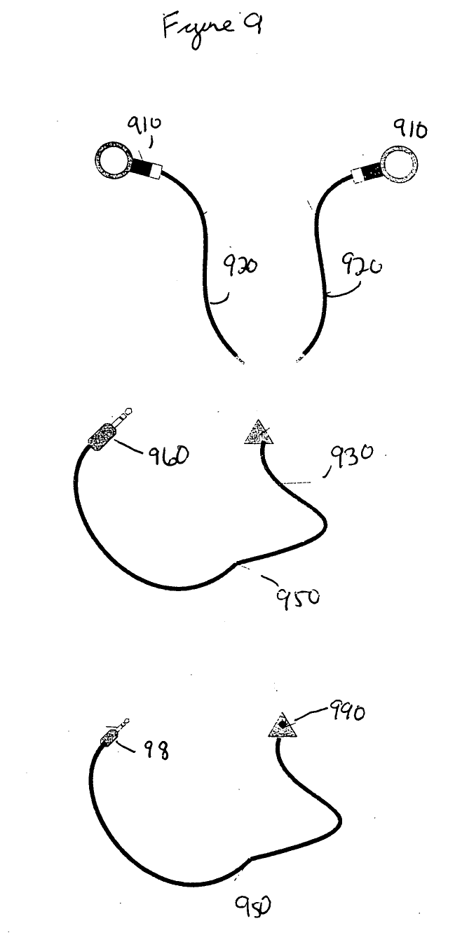

FIG. 9 illustrates an alternative configuration of the audio device with an interchangeable cable for using the audio device as an earphone or communication headset. In this embodiment, the earpiece (810) is permanently connected to the earpiece cable (820). The source cable (950), connector (940), and plug (960) which may be 3.5 mm are integral in that they are connected to form component (930). In this configuration, a user could interchange the component (930) with another similar component to vary the aesthetics or functionality.

In a method of customizing this audio device to enable the functionality of headset communication, the steps include (a) disconnecting the source cable (930) that does not have a microphone from the earpiece cables (920); and (b) attaching at least one earpiece cable (920) to a source cable (950) that includes a microphone (990) and a plug (980) for example that fits into the cellular telephone source.

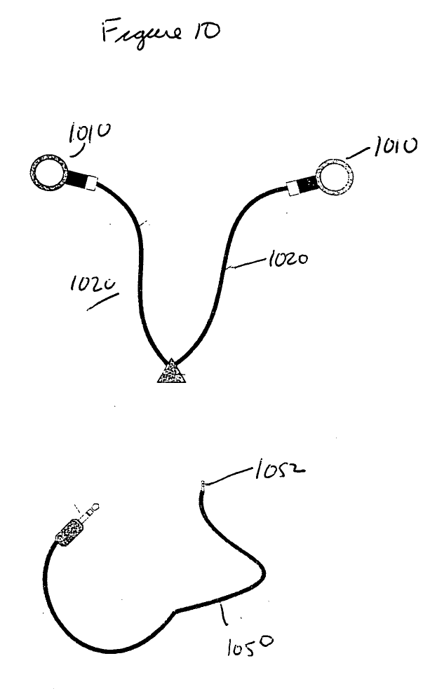

FIG. 10 illustrates an alternative configuration of the audio device in which the earpieces are permanently connected to a connector. In this embodiment, the earpiece cables (1020) are permanently connected to a connector (1040). In this configuration, a user could interchange the source cable (1050) which is detachable connected to the connector (1050) with another source cable (1050) by connecting the source cable plug (1052) to the earpiece connector (1040) to vary the aesthetics or functionality.

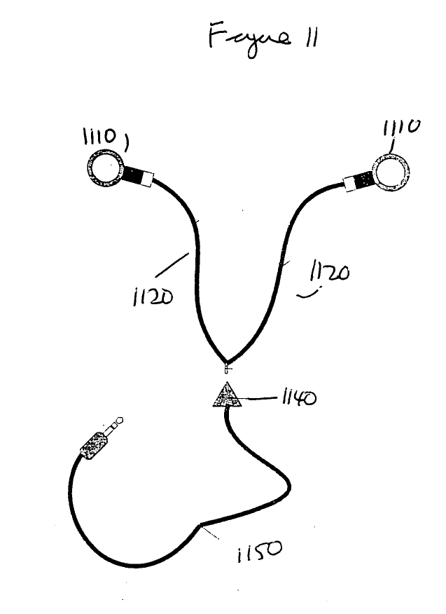

FIG. 11 illustrates an alternative configuration of the audio device in which the earpieces are permanently connected to a plug that connects to a source cable with a connector. In this embodiment, the earpiece cables (1120) are detachably connected to a connector (1140) with a plug (1122). In this configuration, a user could interchange the source cable (1150) with another source cable (1150) by connecting the connector (1140) to the earpiece plug (1122) to vary the aesthetics or functionality.

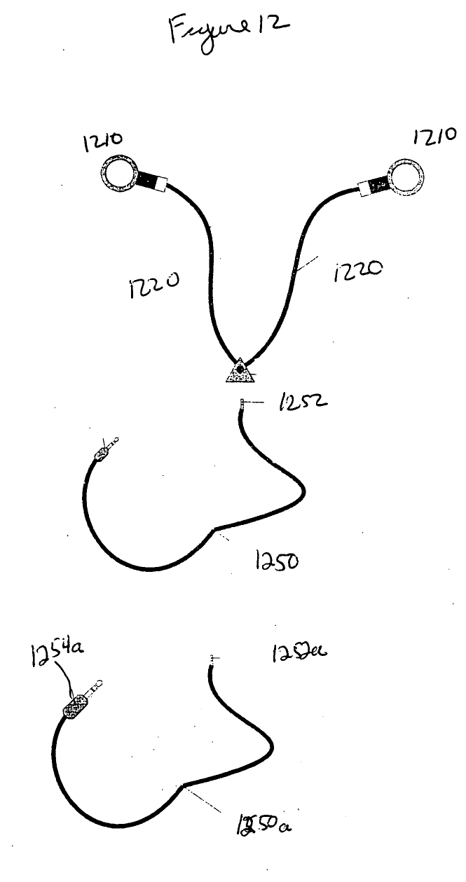

FIG. 12 illustrates an alternative configuration of the audio device in which the earpieces include a microphone on the connector. In this embodiment, the earpiece cables (1220) are permanently connected to each other with a connector (1240) that includes a microphone (1242). The source cable (1250) attaches to the connector (1240) with a plug (1252). The plug (1252) on the source cable (1250) could be used with communication headsets. Under these circumstances, the plug (1252) is a 2.5 mm plug; however, it could be a plug designed for varying manufacturers headset plugs. Another alternative would be for the connector (1240) to be directly or permanently connected to the source cable (1250).

In a method of customizing this audio device to use the device for stereo audio input, which enables features of a communication headset, the steps include (a) disconnecting the source cable (1250) that is designed for headset communication by disconnecting the plug (1252); and (b) plugging a plug (1252a) into the earpiece connector (1240) of a source cable (1250a) that is designed for stereo audio using a stereo audio plug (1254a) that is usually 3.5 mm.

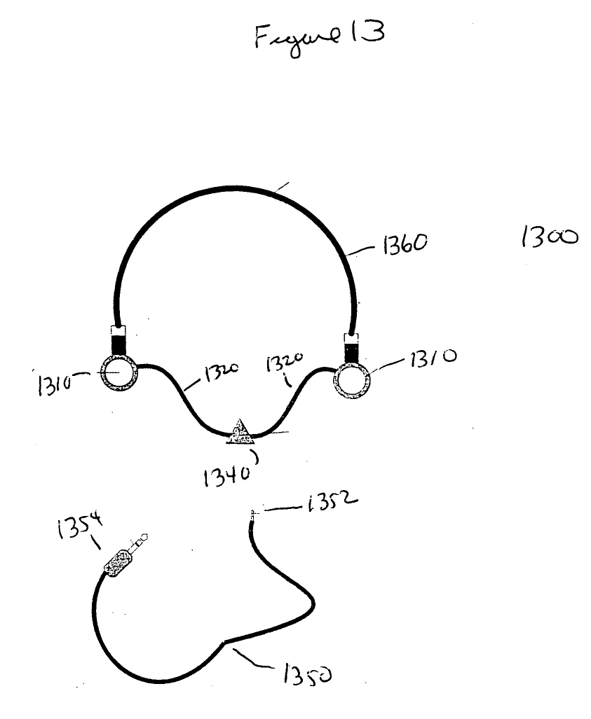

FIG. 13 illustrates an alternative configuration of the audio device in which the stereo speakers are configured as headphones including a behind-the-neck or headband piece (1300). In this embodiment, the earpiece cables (1320) are permanently connected to each other with a curved band (1360) that fits over or behind the user's head. The source cable (1350) attaches to the connector (1340) with a plug (1352). The plug (1352) on the source cable (1350) is designed for use with stereo audio.

In another alternative of this configuration, the connector (1340) would be attached to the source cable (40).

In another alternative of this configuration, the connector (1340) or another component of the device includes a microphone and functionality that allow the headphones to function as a communication headset.

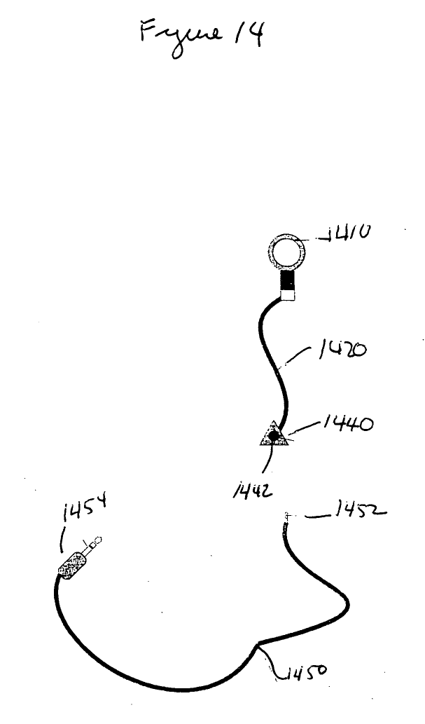

FIG. 14 illustrates an alternative configuration of the audio device in which the device is configured for use as a communication headset. In this embodiment, the earpiece cable (1420) and earpiece speaker (1410) are permanently connected to a connector (1440) that includes a microphone (1442). The source cable (1450) attaches to the connector (1440) with a plug (1452). The plug (1452) on the source cable (1450) is designed for use for communication headsets. Generally, the other plug (1454) is a 2.5 mm plug; however, it could be a plug designed for varying manufacturers headset plugs.

In another configuration of this method, the connector (1440) is directly or permanently attached to the source cable (1450).

In another configuration of this method, the microphone may be housed in the earpiece speaker (1410).

In another configuration of this method, the microphone is attached to the earpiece cable (1420).

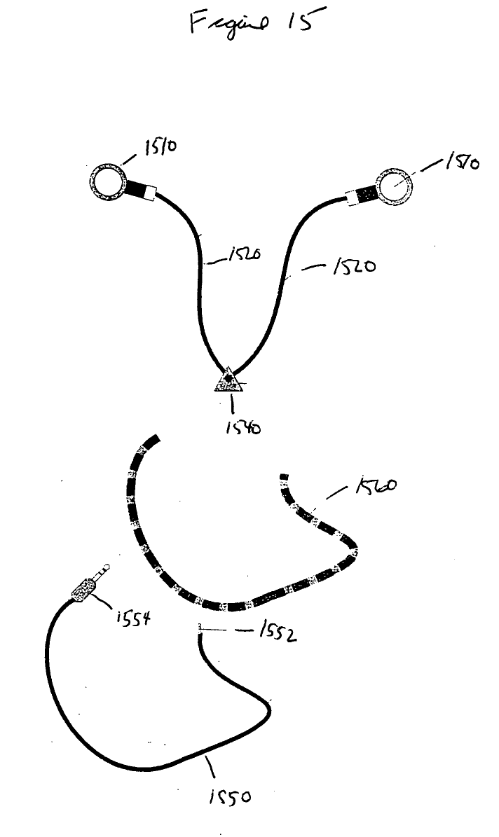

FIG. 15 illustrates a configuration of the hearing device in which the interchangeable hearing device is used with an interchangeable protective and decorative cable cover (1560). In this configuration, the source cable (1550) attaches to the connector (1540) with a plug (1552). In a method of customizing this hearing device to interchange the cable cover, the steps include (a) disconnecting the plug (1552) of the source cable (1550) from a connector (1540); (b) placing a decorative cable cover (1560) over the source cable (1550); (c) connecting the plug (1552) of the source cable (1550) to the connector (1540).

In another configuration of this method, the plug (1552) could be detached in order to replace or remove a cord cover.

In another configuration of this method, cable covers (1560) could be used in conjunction with the earpiece cables (1520) attaching to the earpieces (1510). This could be done by either detaching the earpiece (1510) from the earpiece cable (1520), the connector (1540) from the earpiece cable (1520), or by attaching the cover (1560) by other means to the earpiece cable (1520) or attached components (1510) or connector (1540).

In another configuration of this method, the cover does not require detaching any pieces of the audio device. In this embodiment, the cable cover (1560) can attach to either the source cable (1550) or the attached components (1540, 1552, or 1554), or a combination thereof, with clips or a method such as an opening mechanism such as a zipper that spans the cable cover.

In another configuration of this method, the cable cover includes of more than one cable coverings. An example of this would be to attach a multiple decorative covers that fit on or over the cable such as beads, fabric, wood tubes, and decorative jewels. The cable covers (1560) could be made from reflective materials, materials that glow-in-the-dark or a bright material such as orange so that joggers or bicyclists have additional items which will help identify them to drivers of motor vehicles, therefore increasing safety.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An earpiece device to be worn by a user and to broadcast audio received from a source, comprising:
an earpiece cable to connect to said earpiece device;
a connector connected to said earpiece cable:
a source cable to connect to said source of said audio and to connect to said connector;
wherein one of said earpiece cable or said source cable is detachably connected.

2) An earpiece device to be worn by a user and to broadcast audio received from a source as in claim 1, wherein said earpiece cable is permanently connected and said source cable is detachably connected.

3) An earpiece device to be worn by a user and to broadcast audio received from a source as in claim 1, wherein said earpiece cable is detachably connected and said source cable is permanently connected.

4) An earpiece device to be worn by a user and to broadcast audio received from a source as in claim 1, wherein said connector includes a microphone.

5) An earpiece device to be worn by a user and to broadcast audio received from a source as in claim 1, wherein both of said earpiece cable and said source cable are detachably connected.

6) An earpiece device to be worn by a user and to broadcast audio received from a source as in claim 1, wherein said earpiece includes a plug detachedly connected to said earpiece cable.

7) An earpiece device to be worn by a user and to broadcast audio received from a source as in claim 1, wherein said connector accepts a first plug of the first type and a second plug of a second type.

8) An earpiece device to be worn by a user and to broadcast audio received from a source as in claim 1, wherein said source cable is connected to a microphone.

9) An earpiece device to be worn by a user and to broadcast audio received from a source as in claim 1, wherein said source cable is detachedly connected to said source.

10) An earpiece device to be worn by a user and to broadcast audio received from a source, comprising:
an earpiece cable to connect to said earpiece device;
a connector connected to said earpiece cable:
a source cable to connect to a source of said audio and to connect to said connector;
a cable cover to cover one of said source cable or said earpiece cable.

11) An earpiece device to be worn by a user and to broadcast audio received from a source as in claim 10, were in said cable cover covers only said source cable.

12) An earpiece device to be worn by a user and to broadcast audio received from a source as in claim 10, wherein said cable cover covers only said earpiece cable.

13. An earpiece device to be worn by a user and to broadcast audio received from a source as in claim 10, wherein said cable cover covers both said source cable and said earpiece cable.

14) An earpiece device to be worn by a user and to broadcast audio received from a source as in claim 2, wherein said cable cover includes decorations.

15) An earpiece device to be worn by a user and to broadcast audio received from a source as in claim 10, wherein said cable cover includes glow-in-the-dark material.

16) An earpiece device to be worn by a user and to broadcast audio received from a source as in claim 10, wherein said cable cover includes beads.

17) An earpiece device to be worn by a user and to broadcast audio received from a source as in claim 10, wherein said cable cover includes a decorative jewel.

18) An earpiece device to be worn by a user and to broadcast audio received from a source as in claim 1, wherein said connector receives said audio wirelessly from said source.

19) An earpiece device to be worn by a user and to broadcast audio received from a source as in claim 18, wherein said earpiece cable is attached to a microphone.

20) An earpiece device to be worn by a user and to broadcast audio received from a source as in claim 18, wherein said connector includes a microphone.
